(19) United States
(12) Patent Application Publication
(10) Pub. No.: US 2017/0028733 A1
(43) Pub. Date: Feb. 2, 2017

(54) Method of Digitally Printing and a Digital Printing Apparatus

(71) Applicant: Xeikon IP B.V., Eede (NL)

(72) Inventors: Lode Erik Dries Deprez, Wachtebeke (BE); Werner Jozef Johan Op de Beeck, Putte (BE)

(73) Assignee: Xeikon IP B.V., Eede (NL)

(21) Appl. No.: 15/302,643

(22) PCT Filed: Apr. 8, 2015
(86) PCT No.: PCT/NL2015/050225

§ 371 Date: Oct. 7, 2016

(30) Foreign Application Priority Data
Apr. 10, 2014 (NL) 2012603

(51) Int. Cl. B41J 2/175

(52) U.S. Cl. CPC B41J 2/175

(57) ABSTRACT

In the method of digitally printing an image onto a substrate, a liquid toner dispersion including toner particles in a substantially non-polar carrier liquid is applied to the substrate as a plurality of droplets and in accordance with a pattern, said pattern being based on the image to be printed. The liquid toner dispersion is thereafter splitted into a first and a second layer, which first layer is rich in toner particles and located adjacent to the first surface, which second layer is rich in carrier liquid. At least part of the second layer is removed by means of a liquid removal device; and the compacted toner particles is fused to obtain the image.

### FIELD OF THE INVENTION

The invention relates to a method of digitally printing an image onto a substrate comprising the steps of: applying a liquid dispersion comprising particles and a carrier liquid in a patterned manner to the substrate, said pattern corresponding to the image to be printed. The invention further relates to a digital printing apparatus for carrying out the method.

### BACKGROUND OF THE INVENTION

Such a method and such an apparatus are known from WO95/01404A1. In the known method, use is made of ink droplets comprising insoluble marking particles and a charging agent in a carrier liquid having a high specific resistivity of at least 10⁹ Ω·cm. The marking particles are charged and concentrated into agglomerations of the particles prior to ejection from the ink jet apparatus. Subsequently, they are ejected from the ink in an ink jet printing apparatus in the presence of a non-uniform electrostatic field of significant gradient. This ejection method has the benefit that the size of the droplets are controlled primarily by the voltage on an ejection point plus the ability of the particles to be charged, rather than by the size of an ink jet nozzle. Furthermore, according to the patent application, intrinsically small droplets may be formed, with a reduced tendency for wicking and bleeding due to the high concentration of colorant particles within the droplets.

It is however a disadvantage of the known apparatus, that it tends to have an inherent problem with plate-out of particles, at or near the ejection location, thereby deleteriously affecting performance. There is also a problem with replenishment of non-agglomerated ink in the vicinity of a nozzle and removal of the particle-depleted carrier liquid from the vicinity of the nozzle. Another difficulty is a need for a complex writing head including a number of properly disposed electrodes and associated applied potentials. Moreover, the ink with high resistivity is not a common ink, which is unhandy for the adoption of the technology.

The applicant of WO95/01404 has further improved his process, as published in WO2011/032939A1. According to this application, use is made of a binder-less ink, i.e. an ink comprising merely pigment, dispersing agent and a charging agent. The substrate is herein suitable pre-coated with a basecoat material before printing, the basecoat being in an uncured or partially cured state when the layers of pigment are deposited onto it by the printheads. The pigments are then fixed to the substrate by curing the basecoat using a method suitable for the chosen basecoat.

It is acknowledged by the application that by removal of the binder from the ink, reliability of the printhead and associated fluid handling system is improved, as the ink does not contain materials that would tend to adhere to internal surfaces, filter meshes etc. However, removal of the binder goes with the disadvantage that the toner particles will be less stable and viscosity goes up. Not surprisingly, the examples refer to a process wherein after printing of the final colour and drying the printed substrate, a thermally-curing, water based varnish is applied using an anilox roller, and cured by heating to 200° C. for five minutes. This strongly suggests that the printed ink is not stable without such varnish. Moreover, the curing time of 5 minutes at 200° C. clearly limits the use of the method.

### SUMMARY OF THE INVENTION

It is therefore an object of the present invention to provide an improved apparatus and an improved printing process, which improves, amongst other advantages, the lifetime of the apparatus and provides a stable print with a cost structure that it also makes economically applicable. According to a first aspect, the invention provides a method of digitally printing an image onto a substrate comprising the steps of:
applying a liquid toner dispersion comprising toner particles in a substantially non-polar carrier liquid as a plurality of droplets and in accordance with a pattern to a first surface of the substrate, said pattern being based on the image to be printed;
splitting the liquid toner dispersion into a first and a second layer, which first layer is rich in toner particles and located adjacent to the substrate surface, which second layer is rich in carrier liquid;
removing at least part of the second layer by means of a liquid removal device, and
fusing the compacted toner particles to obtain the image.

According to a further aspect, the invention provides a digital printing apparatus for printing an image comprising:
application means for applying a liquid toner dispersion comprising toner particles in a substantially non-polar carrier liquid in accordance with a pattern and as a plurality of droplets onto a surface of the substrate, said pattern being based on the image to be printed;
means for splitting said liquid toner dispersion into a first and a second layer on the first surface, said first layer being rich in toner particles and said second layer being rich in carrier liquid,
a liquid removal device for at least part of the second layer,
fusing means for fusing the compacted toner particles of the first layer to obtain the image.

According to again a further aspect, the invention provides the use of a liquid toner dispersion comprising toner particles in a substantially non-polar carrier liquid in the digital printing apparatus of the invention for digitally printing an image on a substrate.

In the present invention, the substantially non-polar carrier liquid is removed from the substrate by means of layer splitting into a first and a second layer, which is suitably done by means of the application of an electrical voltage. This second layer, that is rich in carrier liquid, is thereafter removed via a liquid removal device, i.e. as a liquid rather than as vapour. The carrier liquid may thereafter be recycled. More particularly, the liquid toner dispersion is subjected to a charging step prior to the layer splitting. It has been observed that the combination of charging, splitting and carrier liquid removal may result in significant agglomeration and adhesion to the substrate. In this way, the non-polar carrier liquid may be removed mechanically, i.e. substantially without heating to achieve evaporation. The substrate will be arranged, in this embodiment, to be moved along a surface of a member. This member suitably comprises means for applying an electric field, so as to attract the toner particles to the first surface.

Particularly, in accordance with a preferred embodiment of the invention, use is made of a liquid toner dispersion comprising toner particles comprising pigment and binder resin and further provided with dispersing agent residing on a surface of said toner particles. More particularly, the toner particles have an average diameter in the range of 0.5-2.5 microns as measured by laser diffraction. Herein, at least 90%, more preferably at least 95% or even at least 98% (i.e. substantially all) toner particles have a diameter of at most 2.5 microns more preferably less than 2 micron. Although the use of such particles require nozzles with corresponding dimensions and hence relatively much carrier liquid, the effective surface area of larger particles is smaller. This leads thereto, that the viscosity of the toner dispersion can be held low, so as to avoid—at least largely—formation of tails during the jetting from nozzles. Furthermore, the layer splitting will be quicker than when using significantly smaller particles.

The attraction to the surface of the substrate is preferably obtained electrostatically, i.e. by application of an electric field, so that charged toner particles are attracted. This way has been found to be feasible of a splitting into a first layer with compacted toner particles and a second layer which is substantially free of toner particles. More particularly, the toner particles are charged after their application onto the substrate. Such charging is for instance carried out by means of a corona treatment. The affinity to the substrate may also be influenced by means of adding charged components into the application to be jetted on the first surface.

The liquid removal device is embodied, in one preferable embodiment, as a device that contacts the second layer on the first surface, and which is capable of absorbing and/or carrying away liquid. This is understood to be an adequate manner of liquid removal. More preferably, the liquid removal device is configured to rotate in use.

Preferably, use is made of a plurality of liquid removal steps in accordance with the invention, for instance a first liquid removal step directly after charging and resulting layer splitting and thereafter a second liquid removal step. For each of said steps, a liquid removal device will then be present. The number of liquid removal steps will depend on a number of engineering factors, such as the type of ink and the concentration of toner particles, the absorbing capacity of a liquid removal device etc. In one embodiment, this second liquid removal step is carried out after a step of non-contact coalescence, for instance with infrared irradiation or hot air flow.

Furthermore, it is deemed preferable that the substrate is rolled over a cylindrical roller rather than over a belt. The use of a cylindrical roller has the advantage that a voltage may be applied to the cylinder so as to attract the toner particles to the substrate. The cylinder may thereto be metallic or provided with a conductive surface, i.e. comprising a layer of metal or alloy at or near to the surface (for instance below an electrically insulating protective coating).

More preferably, the cylindrical roller has a diameter that is sufficiently large so as to apply a series of inkjet devices and liquid removal devices in the form of rollers to the substrate. Such a cylindrical roller is known and will hereinafter be referred to as a drum. Preferably, the number of rollers onto the drum is preferably at least equal to the number of inkjet heads. More preferably the diameter of the drum is in the range of 0.2 to 3 meter, for instance 0.3 to 2 meter. The use of a drum as a substrate support has the additional advantage that registration of the substrate will be very good and therewith that dimensional changes may be limited or avoided. Therewith the present apparatus and method are feasible for a larger number of substrate types, including for instance thin substrates and polymeric substrates.

Furthermore, a plurality of inks of different colors may be printed. According to the invention, one step or more liquid removal steps are carried out between each jetting stage.

More particularly, it may be suitable in accordance with one aspect of the invention to use a transfer-based printing for a first color and a direct jetting onto the substrate for a second color. The transfer-based printing comprises the steps of jetting and initial removal of carrier liquid by means of charging and resulting layer splitting on a transfer member, and subsequent transfer of the still liquid toner dispersion to the substrate. On the substrate, another liquid removal step is preferably carried out for such printing of the first color. The first and second colors are typically different colors, but could alternatively involve different types of materials, such as a color or pattern in an infrared-detectable manner, in addition to conventional colors, or inks with different characteristics such as different particle sizes.

In one preferred embodiment, the application comprises the step of ejecting droplets from a plurality of nozzles, said nozzles being controlled by a control means so as to generate the desired pattern. The control means is for instance a microcontroller and/or a digital signal processor as known in the art. The liquid toner dispersion is adapted so as to be ejectable from such nozzles. This may be done, in suitable implementations, but adjusting the viscosity, jetting temperature and the size of the marking particles to prevent clogging of the nozzles. The preferred way of jetting is a printing-on-demand type of jetting, as known to the skilled person in the art of inkjet printing. More preferably, use is made of thermal or piezo types of printing head.

One major advantage of the invention according to this embodiment is that the jetting step may be carried out at a lower resolution than the resolution of the image to be printed on the substrate. This lower resolution allows the use of toner particles in the liquid toner dispersion with a relatively large size, for instance in the range of 1-4 microns in diameter. The diameter may herein be made dependent on the particle size, which could be different for different pigments. Thus, suitably, the nozzles have a lower resolution than the image to be printed. Such lower resolution is enabled in that non-polar carrier liquid may be removed mechanically and therewith quickly. The volume (and flow rate) of carrier liquid that can be removed mechanically, is significantly higher. The printing of additional liquid as a result of the lower resolution therefore may be dealt with in the apparatus and method of the invention.

Also when jetting in a low resolution, a sufficiently high resolution may be obtained and intermixing of droplets can be prevented or minimized due to the charging of the toner immediately after the jetting process and thus preventing the spreading of the pigmented particles.

The increase in resolution may for instance be achieved by printing in a plurality of rows, more precisely with nozzles in several rows. Alternatively or additionally, a lithographic or electrographic patterning step could be added. In relation to this embodiment to increase resolution, compaction and carrier liquid removal are preferably carried out in between printing (i.e. jetting) stations of the same color, i.e. between the rows. Therewith, increased printing resolution can be obtained without increased spreading of the image due to the electrostatical fixation which occurs directly on the substrate.

Again more preferably, use is made of a liquid toner dispersion that is substantially uncharged when applied as droplets, i.e. when introduced to the printing head for jetting to the substrate. Thus the ‘initial’ liquid toner dispersion is substantially free of any separate charging agents and it is not charged by means of a charging device.

Additionally, the concentration of toner particles in the liquid dispersion may be adjusted. The step of ejecting droplets from a plurality of nozzles will hereinafter also be referred to as the step of jetting. Preferably, use is made of liquid toner dispersion with a Newtonian viscosity behaviour. The toner dispersion is designed such that the flow through in the inkjet head is not changed dependent upon the liquid velocity. This is particularly a matter of viscosity setting as known to the skilled person. The final toner concentration of the toner particles in the dispersion will be determined taking into account the basic viscosity and the Newtonian behaviour and may suitably vary from 10 to 40% by weight.

In one preferred embodiment of the invention, the substrate is a substantially non-carrier liquid absorbing substrate, such as a polymer substrate. This embodiment is deemed suitable so as to reduce any undesired deformation of a substrate. The term polymer substrate is herein used in accordance with the art to refer to synthetic polymers and to exclude paper-type substrates. Examples of suitable polymer substrate are polycarbonate, polyethylene, polypropylene, polyester and polyvinylchloride substrates. However, alternatives such as coated substrates absorbing at most part of the carrier liquid are not excluded. More particularly, the substrates used are relatively thin, for instance less than 100 microns, suitably at most 50 microns or most 20 microns. The use of jetting for these substrates limits the application of force. Such force easily induces dimensional instabilities that are to be prevented.

The fusing step in the process of the invention transforms the compacted toner particles into the image by means of coalescence. This fusing moreover adapts the toner particles for adhesion to the substrate. Any residual carrier liquid may be absorbed into the substrate, mechanically removed and/or evaporated. The advantage of this embodiment is the elegant machine design.

Suitably, the fusing is carried out so as that the compacted toner particles coalesce and that the first layer of toner particles separates into a coalesced toner particle phase and a carrier liquid phase. The coalesced toner particle phase may then adhere to the substrate, while the carrier liquid phase may be removed.

Suitably the fusing is carried out in a fusing station with a first part for coalescence and a second part for removal of the residual carrier liquid phase (if any left) and (if needed) further complete contact fusing. The first part thereto suitably comprises an apparatus for non contact fusing comprising means for infrared heating, ultrasonic fusing, microwave fusing, hot air fusing or steam fusing. Alternatively, it may comprise an apparatus suitable for contact fusing, such as a heated roller. The carrier liquid phase is preferably removed without evaporation, for instance by moving away the carrier liquid phase. Examples include rollers with scrapers on, means for blowing off the carrier liquid phase, means for suction of the carrier liquid phase, means for a cleaning web or means for applying foam. When rollers are used they can be heated or non heated. When heated rollers are used on the substrate, they can also function as gloss regulation means and/or fusing means to further improve the adhesion.

Suitably, the liquid toner dispersion is stabilized, at least primarily, on the basis of steric stabilisation, rather than an electrical stabilisation. Such steric stabilisation is obtained for instance in the choice of the dispersing agent. If a charging agent such as a metal salt were chosen as dispersing agent, the stabilisation of the dispersion would be primarily realized by electrical repulsion. Such a liquid toner dispersion has another behaviour and moreover has different conductivity values than those in accordance with the invention. Rather, if a dispersing agent is chosen comprising groups that create steric hindrance, a steric stabilisation is obtained. Such groups creating steric hindrance are for instance organic chains, suitably with side chains. The chains may be provided with polar groups, such as carboxyl-groups and/or amino-groups. Suitable groups are for instance polymers of (hydroxylated) fatty acids and polyolefines. In one particularly preferred embodiment, the liquid toner dispersion of the invention is intrinsically uncharged, and gets charged only by means of a charging treatment, such as a corona treatment. More particularly, the chargeable groups are primarily present at the surface of the toner particle rather than coupled to the tails extending in the carrier liquid.

More preferably, the dispersing agent is herein of the so-called hyper-dispersant type. Such a dispersing agent is coupled or anchored to the particle with several functional groups and is known to provide optimum properties. Therewith, a docking interaction of the dispersing agent with the toner surface is realized, together with the presence of chemical moieties that provide dispersion stability (so called tails). In a further embodiment, the process of the invention comprises a step of reducing the dispersing ability of the dispersing agent. This is more particularly achieved by means of the use of a decomposable dispersing agent. Subsequent to this reduction step, another carrier liquid removal step is carried out, so as to remove the liquid that is not longer kept within the dispersion as a consequence of the reduced dispersability. This reduction of the dispersing agent may be done as part of the fusing step. The agent will thereafter disperse the toner particles less adequately, resulting in further compacting of the toner particles.

Thereto, the dispersing agent suitably comprises a stimulus-responsive group that may be stimulated, for instance by means of irradiation or the like. Preferably, the stimulus responsive group comprising a photolabile group, i.e. it is for instance a derivative of a photo decomposer. Preferably, the stimulus is visible light, UV-light, infrared or microwave radiation or heat. Most preferably, the stimulus is UV-light. The UV-light or other stimulus may be applied by means of treatment means, i.e. an illumination source and/or heat source that may be focussed on a portion of a surface of the transfer member.

In again a further embodiment, the liquid toner dispersion may be modified by means of addition of a chemical agent. This chemical agent may for instance be present on the final substrate when the liquid toner dispersion is applied thereto, or is added subsequently. It could further be sprayed simultaneously with the jetting of the liquid toner dispersion, but from separate nozzles. Its presence could be either in solid form or as a solution, depending on the type of agent. A solution appears favourable. The agent may be a reagent chosen to start a reaction, for instance with the dispersing agent, so as to change the dispersing ability thereof. The agent may further be an additive, for instance an acid or alkaline agent, or a binder resin or another agent.

### BRIEF INTRODUCTION OF THE FIGURES

These and other aspects of the invention will be further elucidated with reference to the figures, which are purely schematical and not drawn to scale and wherein same reference numerals in different figures refer to equal or corresponding features, and wherein:

FIG. 1 shows in a diagrammatical cross-sectional view a first embodiment of the apparatus; and

FIG. 2 shows in a diagrammatical view a second embodiment of the invention, according to which the jetting occurs directly on the substrate.

### DETAILED DESCRIPTION OF ILLUSTRATED EMBODIMENTS

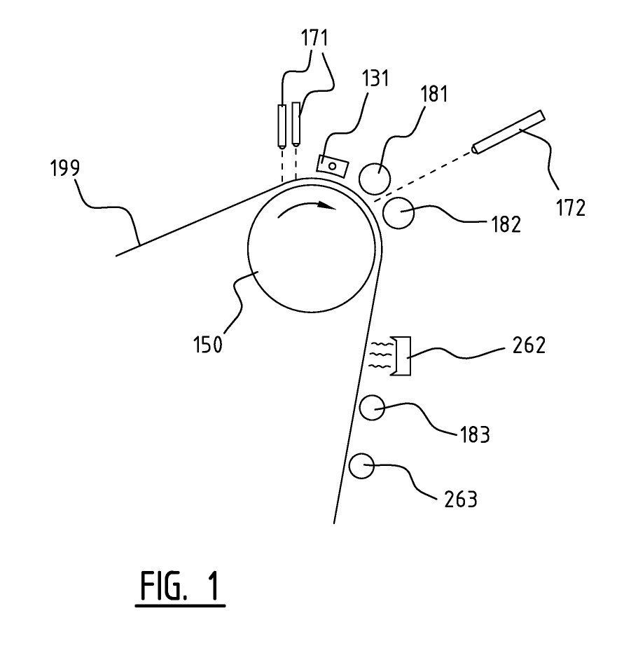

FIG. 1 shows in a diagrammatical cross-sectional view a first embodiment of the apparatus of the invention. In the shown embodiment, there is a single central member 150, over which the substrate 199 rolls and onto which application means 171 provide the liquid toner dispersion. The single central member 150 is sufficiently large, so that the substrate 199 contacts the surface of the central member 150 at the area where jetting from the application means 171 occurs. This contacting of member 150 and substrate 199 suitably occurs over substantially the entire width of the substrate 199. This contact is preferably needed to establish a good dimensional stability of the substrate at the moment of jetting the dispersion droplets to the substrate. Contacting also means that toner particles applied as droplets will be attracted by the electric field defined by the central member 150 upon their arrival onto the substrate 199. If the substrate 199 is not in contact with the central member 150 at the area where the droplets are applied, there will be a bigger risk of spreading of the droplets.

In accordance with the invention, use is made of a liquid dispersion of toner particles comprising a substantially non-polar, and hence non-aqueous carrier liquid. Since evaporation of such a non-aqueous non-polar carrier liquid is neither energy efficient nor healthy, at least a significant part of the carrier liquid is removed in this invention by means of one or more liquid removal devices 181, 182, after passing the charging device 131. The liquid removal devices remove the carrier liquid in the liquid phase, for which they are ‘mechanical’, i.e. they contact the carrier liquid to be moved and the removal then occurs by means of a mechanical action of the removal device, such as a movement or rotation of the removal device.

In order to ensure an appropriate removal of the carrier liquid without negative impact on the final image (and hence any pattern of toner particles), the toner particles are suitably attracted to the first surface, which is in this embodiment the surface of the central member 150. In this embodiment, the attraction is embodied in that charged toner particles are attracted by means of an electric field established between the rollers 181, 182 and the member 150.

The charging of the toner particles is achieved, in this embodiment, by means of a charging device 131. The charging device is for instance is designed for the provision of a corona treatment. However, alternative charging devices as known to the skilled person in the field of liquid toner processes are not excluded. In an alternative embodiment, the charging device may be embodied in the form of a member that is in rotational contact with the transfer member 150.

The electric field is suitably applied between the central member 150 and the liquid removal devices 181, 182, for instance by setting those at mutually different potentials. The use of an electric field set onto the central member 150 has the advantage that the toner particles are constantly attracted, as long as they are present on the central member 150. Therewith, there is a sufficient time for carrier liquid removal and gradual agglomeration or caking of the toner particles.

The removal of the carrier liquid, that further may contain dispersing agent and any further additives, allows recycling. The recycled carrier liquid may for instance be used so as to bring the liquid toner dispersion to a predefined concentration (i.e. dilution) suitable for the jetting step. The removal occurs with at least one liquid removal device or member 181 is present. In the present example a first and a second liquid removal member 181, 182 are present. The liquid removal members 181, 182 may be embodied as rollers with a surface to which an—oily, substantially nonpolar—carrier liquid will adhere. This surface is for instance a metal surface, but could alternatively be a hydrophobic surface of polymer material such as a polyurethane, silicone or a fluorinated polyolefine such as PTFE. The liquid removal member 181 and/or 182 may be, in one embodiment, an absorbing member, with a sponge, a porous layer or the like at its outer surface.

It is therefore feasible that an electric field is applied in the nip between at least one of the liquid removal members and the transfer member 150. Such an electric field may further help to keep the charged liquid toner dispersion stable and in place when the carrier liquid is split into a first and a second layer. For sake of clarity it is added herein, that the first and second layer need not to be distinct layers, but may be form a continuum, wherein the concentration of toner particles in particular, decreases with the distance to the surface of the transfer member 150.

Furthermore the application means 171 suitably comprise inkjet heads. More suitably a plurality of ink jet heads is arranged in at least one row, but possibly more than one row, such as two rows as shown in FIG. 1 or even three or more rows. The rows are aligned with the length of the central member 150, i.e. substantially parallel to the axis of the central member. The ejection of liquid toner dispersion from the individual ink jet heads is controlled by means of a controller—not shown, in correspondence to an image to be printed on the substrate 199. The inkjet heads may be movable, or have movable parts so that a single printing head may be used for printing dispersion on several adjacent locations. This arrangement may be optimized to arrive at a good compromise between price, operation speed and controllability. Suitably, use is made of ink jet heads with a resolution that is low in comparison to the resolution of the image to be printed. This is deemed beneficial, as it enables jetting of toner particles with a comparatively large diameter. The increase in resolution is for instance achieved by printing in a series of rows. The real resolution of an image is the hardware resolution multiplied by the image depth. Offset is 2400 dpi one level (ink or no ink)—thermo sublimation is 300 dpi but at least 32 or 64 grey levels at one spot making a resolution equivalence of 20,000. A good electrophotographic device has for instance a resolution of 1200 dpi and can f.i. print 4 levels per pixel (0-25-50-75-100%) yielding a resolution value of 4800. Therefore, printing in a plurality of rows (for instance 3-6) with a low or intermediate resolution, for instance in the range of 300 to 800 dpi is deemed suitable to obtain a required resolution.

In relation to this embodiment to increase resolution, compaction and carrier liquid removal are preferably carried out in between printing (i.e. jetting) stations of the same color. Therewith, increased printing resolution can be obtained without increased spreading of the image due to the electrostatical fixation which occurs directly on the substrate.

The apparatus is further provided with fusing means. Such fusing means comprise means 262 for non-contact coalescence, for instance in the form of infrared radiator and/or an ultrasonic tool. According to this embodiment, the fusing means further comprise means 263 for contact fusing, particularly in the form of a heated roller. An additional liquid removal means 183 is provided between the means 262 for non-contact coalescence and the means 263 for contact fusing.

For sake of clarity, the term ‘substantially non-polar’ refers in the context of the present invention to a compound that is overall non-polar even though it may contain some polarisable groups such as amide, carboxyl or hydroxyl-groups. The carrier liquid is for instance a mineral oil, vegetable oil, chemically derived from a vegetable oil or a silicone fluid.

The toner particles, according to this invention, comprise colored particles (also called ink particles or pigment) and a binder resin. The binder resin is a polymer, preferably transparent, that embeds the ink particles and optionally other compounds like melt rheological adjustment compounds or fillers. The toner particles have a diameter of typically about 0.5 to 2.5 μm, and more preferably in the range of 1-2 micron, such as 1.0-1.5 μm, said diameter being measured directly after the preparation of the liquid toner dispersion (rather than after the jetting step).

Suitably, the size of the toner particles in the applied toner liquid dispersion is made substantially monodisperse. Appropriate milling and filtering may be carried out to arrive at such dimensions. Moreover, the toner particles that are typically formed by mixing pigment and binder resin can be formed with a modified binder resin, for instance a binder resin with reduced molecular weight. The toner particles have a concentration of about 40-95% of the binder resin. Preferably a polyester resin is used as binder resin. Also other types of resin having a very low or no compatibility with the carrier liquid and dispersing agent can be used. Preferably, the resin has a high transparency, provides good color developing properties and has a high fixing property on the substrate. The carrier liquid according to the invention, can be any suitable liquid as is known in the art, and may be silicone fluids, hydrocarbon liquids and vegetable oils, or any combination thereof.

The dispersing agent used in the liquid toner dispersion is in one suitable embodiment a polymeric dispersing agent, and more preferably a dispersing agent comprising an ethylene imine, polyethylene imine or polyallylamine backbone. The dispersing agent may further be based on a polyhydroxystearate and/or polycaprolactone. The polymer may be a homopolymer, a copolymer, which is either a random copolymer or a block copolymer. For instance a random copolymer of vinylpyrrolidone and long chain olefins may be used. Moreover, the polymeric dispersing agent may contain dispersing functional groups that have been grafted onto a backbone. The backbone is for instance a binder polymer suitably for use in combination with toner particles. Alternatively, the dispersing agent is ester-based, such as for instance based on fatty acids. Sorbitan esters constitute a suitable example. Typical examples of dispersing agents are solsperse 11000, solsperse 13490, solsperse 11200, Antaron V216, Antaron V220, Ajispers 817, tilosperse 8300 or tilosperse 13000, which dispersing agents are commercially available. The dispersing composition may further contain a plurality of dispersing agents.

In the embodiment shown in FIG. 1, but that is not deemed essential, an illumination source 172 is present. Herewith, a stimulus responsive group of a dispersing agent in the liquid toner dispersion may be illuminated so as to achieve a modification of the dispersing ability of the dispersing agent This stimulus application station can be located before the carrier liquid removal starts, in between the carrier liquid removal means (as in FIG. 1) or after the carrier liquid removal means. The location may be chosen depending on the response rate and effect on the charging.

Preferably the dispersing ability of the dispersing agent is reduced. The illumination source 172 principally may be arranged at a variety of locations. A preferred location is a location downstream of a first liquid removal device 181. Due to the resulting decrease in dispersibility, liquid may appear after the illumination. It is therefore deemed suitable to provide a liquid removal device 182 downstream of the said illumination source 172. This liquid removal device 182 is for instance embodied as a roller (for mechanical liquid removal) or alternatively as heating device. It is not excluded to reduce the dispersing ability of the dispersing agent in more than one step, for instance a first step and a second step. This may be further implemented by means of the intensity of the illumination, and/or the frequency of an illumination protocol.

In this embodiment, the dispersing agent comprises a stimulus-responsive group that may be stimulated, for instance by means of irradiation or the like. Preferably, the stimulus responsive group comprising a photolabile group, i.e. it is for instance a derivative of a photo decomposer. Preferably, the stimulus is visible light, UV-light, infrared or microwave radiation or heat. Most preferably, the stimulus is UV-light, which is applied, in this example embodiment, by means of the illumination source 172.

The photo decomposer as used in this example is a compound that decomposes after exposure to UV light, visible light or infrared light and causes a covalent bond to break. The inventors have found that such photolabile groups may be incorporated into the dispersing agent, without loss of the responsiveness to the stimulus. Reference is made to the non-prepublished application NL2011064 in the name of Applicant, which describes these photolabile groups and their modification upon stimulation in more detail, which application is herein included by reference.

In one suitable embodiment, the photolabile group comprises a benzoyl-group. Herewith, good results have been obtained. More particularly, the benzoyl-group is arranged such that a rearrangement within the stimulus responsive part occurs. Such rearrangement involves for instance formation of a cyclic structure. Electron-donating groups may be present to simplify or enable formation of such cyclic structure. The benzoyl-group (i.e. -Ph-(C═O)—) tends to give a relatively stable radical intermediate. Moreover, the phenyl-group Ph may be substituted accordingly, for instance to attach an anchoring part. Further groups may be coupled to the carbonyl-group, for which a variety of options are available, including optionally substituted alkyl, such as a substituted methyl and acid groups. Preferred examples hereof include a phenyl-methylgroup, with the methyl adjacent to the benzoyl, which methyl may be further substituted, for instance with hydroxyl, alkoxy, amine, methyl or other alkyl or even aralkyl. The acid group could be a carboxylic acid, but is preferably a phosphonic acid or sulphonic acid or any such acid as known to the skilled person. Therefore, this benzoyl-group is a photolabile group that can suitably be integrated into the dispersing agent of the invention.

In a further implementation, the stimulus responsive part comprises a photolabile group is selected from the group consisting of 2-phenyl-2-hydroxy-1-phenylethanone moiety; 2-oxo-1,2-diphenylethyl formate moiety; hydroxyacetophenone derivative; alkylaminoacetophenone derivative; benzyl ketal derivative a TPO derivative (i.e. a derivative of (diphenylphosphoryl)(2,4,6-trimethylphenyl)methanone); a TPO-L derivative (i.e. a derivative of phenyl-(2,4,6-trimethyl-benzoyl)-phosphinic acid ethyl ester); a BAPO derivative ((i.e. a derivative of [phenyl-(2,4,6-trimethyl-benzoyl)-phosphinoyl]-(2,4,6-trimethyl-phenyl)-methanon); or a combination thereof.

In another suitable embodiment, the stimulus responsive part comprises a photolabile group which forms a benzoylgroup after the exposure to the stimulus. Examples include an ortho-nitrobenzyl moiety and a bis(2-nitrophenyl)methyl formate moiety.

In again another suitable embodiment, the stimulus responsive part comprises a diazene as a photolabile group. An example is an dialkyl diazene moiety, such as for instance (E)-di(propane-2-yl)diazene moiety.

For sake of clarity, reference is made hereabove to photolabile groups only. If the stimulus is heat, the relevant group will be evidently heat-labile. For the sake of simplicity, this alternative is not separately discussed, but its operation is fully in line with the photolabile group. The further remarks are therefore also applicable to the embodiment of heat-labile groups, which can decompose in the drying section of the printer or during aging at elevated temperature.

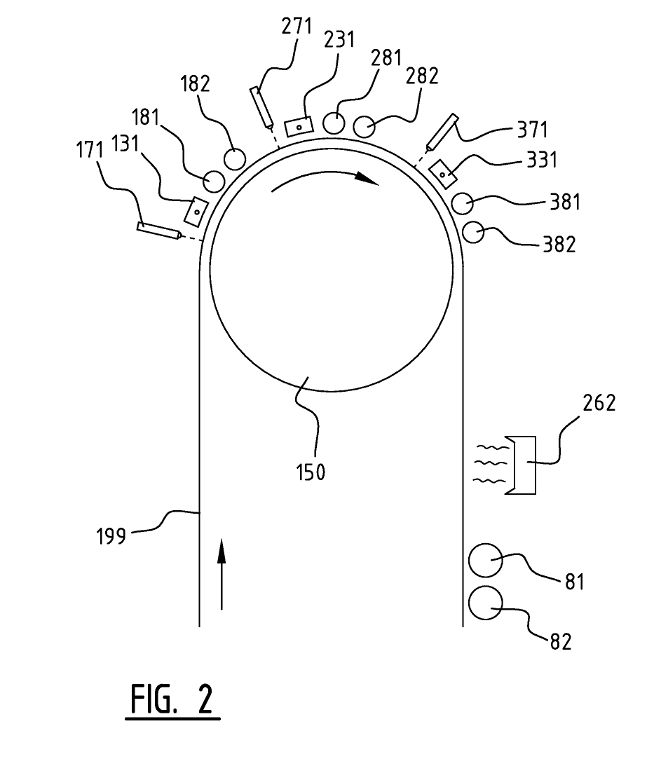

FIG. 2 shows a diagrammatical, cross-sectional view of the apparatus in a again further embodiment for printing directly on non carrier liquid absorbing substrates. An advantage of this invention is to reduce dramatically the amount of carrier liquid that has to be removed in the final phase when polymeric substrates are used. The small amount of carrier liquid which cannot be removed mechanically is reduced to such an extent that more easily final evaporation can take place with a reduced amount of energy so that the substrate is not thermally deformed and the energy cost is drastically reduced.

As shown in FIG. 2, the apparatus comprises three jetting stages, each with application means 171, 271, 371 preferably in the form of nozzles, charging means 131, 231, 331, first liquid removal means 181, 281, 381 and second liquid removal means 182, 282, 382. It will be understood that the number of three jetting stages is merely an example and that the number could alternatively be 2, 4, . . . , 8 or even higher. Preferably, each jetting stage is used for the provision of a specific color. However, it is not excluded that several jetting stages may be provided for ink in the same color but in a different resolution. For instance, the first jetting stage could have a relatively low resolution, while a further jetting stage operates at a higher resolution. The resolution herein is suitably implemented by means of the resolution of the application means, such as the type of nozzle or other means, jetting pressure, distance to the substrate 199. The term ‘color’ herein also includes the option of inks that are invisible for a human eye and may be applied as a security feature.

The options discussed in relation to preceding embodiments also apply to this embodiment: use could be made of more than one row of nozzles, and treatment means may be provided between individual jetting stages where needed so as to prevent that colors get mixed. While liquid removal devices 181-381, 182-382 are shown as isolated devices, it will be understood that the liquid removed by such liquid removal device is again removed from the liquid removal device. One suitable manner of doing this may be the integration of a channel in the liquid removal device, along the central axis. Furthermore, liquid thrown out of the removal device (as in a centrifuge) may be caught in a container. Alternative methods for removal may be apparent and will depend on the specific implementation, such as the material of the liquid removal device (porous/non-porous, adhesion of a liquid film to the surface), rotation speed, diameter. While all liquid removal devices are shown to be identical, this is by no means necessary. Fusing devices 262 is followed by 81, 82 are moreover shown. These devices 81, 82 are operative to achieve a fusion of the ink particles, for instance by means of heating and eventually additional carrier liquid removal after the film formation and the adhesion to the substrate has taken place. A reduction of the dispersing ability of the dispersing agent as discussed before could be part of such fusing treatment carried out before fusing devices 262.

1. A method of digitally printing an image onto a substrate, comprising:
applying a liquid toner dispersion comprising toner particles in a substantially non-polar carrier liquid as a plurality of droplets and in accordance with a pattern to a surface of the substrate, said pattern being based on the image to be printed;
splitting the liquid toner dispersion into a first and a second layer, which first layer is rich in toner particles and located adjacent to the substrate surface, which second layer is rich in carrier liquid;
removing at least part of the second layer by a liquid removal device; and
fusing the compacted toner particles to obtain the image.

2. The method of claim 1, wherein the splitting of the liquid toner dispersion into a first and second layer occurs by attracting toner particles to the substrate surface by application of an electric field.

3. The method as claimed in claim 1, which method further comprises charging the liquid toner dispersion.

4. The method as claimed in claim 1, wherein removal of the liquid comprises bringing the liquid removal device in contact with the second layer, so that the removed part of the second layer flows away in or on said liquid removal device, the liquid removal device configured to rotate in use.

5. The method as claimed in claim 1, wherein the liquid toner dispersion comprises particles with an average diameter in the range of 0.5 to 2.5 microns.

6. The method as claimed in claim 1, further comprising modifying a dispersing ability of a dispersing agent of the liquid toner dispersion.

7. The method as claimed in claim 1, wherein applying the liquid toner dispersion in accordance with a pattern comprises ejecting the liquid toner dispersion from a plurality of nozzles of printing or spraying heads onto the substrate, wherein said plurality of nozzles are controlled for ejecting liquid toner dispersion in accordance with said pattern.

8. The method as claimed in claim 7, wherein the ejecting resolution is lower than a resolution of the image to be printed on the substrate.

9. The method as claimed in claim 1, wherein the application of liquid toner dispersion occurs in a series of stages, each stage comprising an application step, a layer splitting step and a liquid removal step.

10. The method as claimed in claim 1, wherein the substrate is a substantially non-carrier liquid absorbing substrate.

11. The method as claimed in claim 1, wherein the substrate has a thickness of less than 100 microns.

12. A digital printing apparatus for printing an image on a substrate, comprising:
an application device configured to apply a liquid toner dispersion comprising toner particles in a substantially non-polar carrier liquid in accordance with a pattern and as a plurality of droplets onto a surface of the substrate, said pattern being based on the image to be printed;
a splitter device configured to split said liquid toner dispersion into a first and a second layer on the substrate surface, said first layer being rich in toner particles and said second layer being rich in carrier liquid,
a liquid removal device configured to remove at least part of the second layer, and
a fusing device configured to fuse the compacted toner particles of the first layer, to obtain the image.

13. The digital printing apparatus as claimed in claim 12, wherein the application device comprises a plurality of nozzles for ejecting droplets of the liquid toner dispersion and a control device is configured to control said nozzles to apply the liquid toner dispersion according to the desired pattern.

14. The digital printing apparatus as claimed in claim 12, wherein the splitter device is configured to apply an electric field on/at the first surface, so as to attract charged toner particles to the first surface.

15. The digital printing apparatus as claimed in claim 12, wherein the liquid removal device comprises a liquid absorbing member that, in use, rotates and contacts the second layer on the substrate surface.

16. The digital printing apparatus as claimed in claim 12, further comprising a drum for registration of the substrate, and wherein the application device, the splitter device, and the liquid removal device are arranged relative to the drum, so that the substrate is supported by the drum in the course of droplet application, layer splitting, and liquid removal.

17. The digital printing apparatus as claimed in claim 12, comprising a plurality of printing stages located downstream of each other, each printing stage comprising an application device, a splitter device, and a liquid removal device.

18. Use of a liquid toner dispersion comprising toner particles in a substantially non-polar carrier liquid in the digital printing apparatus as claimed in claim 12 for digitally printing an image on a substrate.

19. Use as claimed in claim 18, wherein the liquid toner dispersion has a concentration of toner particles in a concentration of higher than 15 wt % and having a Newtonian viscosity behaviour.

20. Use as claimed in claim 18, wherein the toner particles have an average diameter in the range of 0.5 to 2.5 microns.
